(19) United States
(12) Patent Application Publication
(10) Pub. No.: US 2026/0039134 A1
(43) Pub. Date: Feb. 5, 2026

(54) NETWORK DEVICES FEATURING BATTERY UNITS

(71) Applicant: Cisco Technology, Inc., San Jose, CA (US)

(72) Inventors: Eric A. Voit, Bethesda, MD (US); Joel Richard Goergen, Soulsbyville, CA (US); Beth Kochuparambil, Morgan Hill, CA (US); Shobhana R. Punjabi, San Jose, CA (US); Ruqi Li, Fremont, CA (US); John W. Beecroft, San Jose, CA (US); Alpesh U. Bhobe, Sunnyvale, CA (US); Kami Hurst, San Jose, CA (US)

(21) Appl. No.: 18/793,711

(22) Filed: Aug. 2, 2024

(51) Int. Cl. H02J 7/00; H01M 10/42; H01M 10/46

(52) U.S. Cl. CPC H02J 7/0068; H01M 10/425; H01M 10/465; H01M 2010/4271

(57) ABSTRACT

Devices, systems, methods, and processes for dynamically controlling power supplied from power supply units (PSUs) and battery units of network devices are described herein. Generally, network devices rely on redundant power supplies or large hold-up capacitors to address power supply issues. Redundant power supplies lead to sub-optimal efficiency, while hold-up capacitors lead to bulky network device taking up space within the PSUs. Therefore, the present disclosure describes disposing one or more battery units in linecard slots or PSU slots. The battery unit may provide redundancy for the power supply and can act as an effective filter for power signal fluctuations. The battery units and the PSUs are dynamically controlled based on a load demand associated with the network device and power supply sources connected to the network device. Thus, the battery unit actively participates in load sharing with the PSUs to operate the PSUs more efficiently.

The present disclosure relates to network devices. More particularly, the present disclosure relates to dynamically controlling power supplied by power supply units (PSUs) and battery units of network devices.

### BACKGROUND

Networking equipment (for example, routers, switches, servers, etc.) typically require reliable and uninterrupted power supply for their operation. To address potential power issues such as voltage fluctuations and power instability, network device architectures are often designed with redundant power supply units (PSUs) and hold-up capacitor banks. These components ensure continuous operation by providing backup power and mitigating the effects of power fluctuations. Redundant PSUs are integrated to create fault tolerance, ensuring that if one PSU fails, the other can seamlessly take over without interrupting the device's operation.

When redundant PSUs are added to a network device, each PSU may operate below its optimal efficiency range. This suboptimal operation may occur due load sharing between multiple PSUs. Thus, preventing any single PSU from reaching its most efficient operating point. Consequently, the overall energy efficiency of the system may decrease.

Furthermore, the need for redundancy requires the duplication of hold-up capacitors across each PSU. Hold-up capacitors may maintain power during brief interruptions or fluctuations in the power supply, ensuring stable operation. However, duplicating these capacitors in each PSU adds to the bulk and takes up valuable space within the PSUs. This redundancy, while necessary for ensuring power stability and reliability, can result in inefficient use of space and resources, complicating the design and maintenance of the networking equipment.

### SUMMARY OF THE DISCLOSURE

Systems and methods for the present disclosure relates to dynamically controlling the power supplied from power supply units and battery units of network devices in accordance with embodiments of the disclosure are described herein. In some embodiments, a device includes a processor, one or more power supply units (PSUs), a plurality of linecard slots, a battery unit disposed within a linecard slot of the plurality of linecard slots, wherein the one or more PSUs and the battery unit are configured to supply power to the device, and a memory communicatively coupled to the processor, wherein the memory includes a power management logic that is configured to determine a load demand associated with the device, monitor one or more power sources providing power to the battery unit and the one or more PSUs, and dynamically control the power supplied from the one or more PSUs and the battery unit based on the determined load demand and the monitored one or more power sources.

In some embodiments, one or more power sources include at least one of a utility power grid, a renewable energy source, or a non-renewable energy source.

In some embodiments, in response to the one or more power sources including the utility power grid, the power management logic is further configured to facilitate one or more grid support functions via the battery unit.

In some embodiments, the one or more grid support functions include at least one of frequency regulation, voltage control, or load balancing for the utility power grid.

In some embodiments, in response to the one or more grid support functions including load balancing, the power management logic is further configured to detect a time period during which a power grid load demand is less than a threshold load demand, and operate the battery unit in a charging mode during the detected time period, wherein the charging mode includes storing excess energy from the utility power grid, during the detected time period, in the battery unit.

In some embodiments, in the charging mode, the battery unit is configured to receive a power supply signal from the utility power grid, and filter one or more fluctuations in the power supply signal to store the excess energy.

In some embodiments, in response to the one or more grid support functions including load balancing, the power management logic is further configured to detect a time period during which a power grid load demand is greater than a threshold load demand, and operate the battery unit in a discharging mode during the detected time period, wherein the discharging mode includes releasing energy from the battery unit to the utility power grid during the detected time period.

In some embodiments, in response to the one or more power sources including the renewable energy source, the power management logic is further configured to monitor an energy output associated with the renewable energy source.

In some embodiments, the power management logic is further configured to detect that the energy output associated with the renewable energy source exceeds the determined load demand and operate the battery unit in a charging mode in response to detecting that the energy output exceeds the determined load demand, wherein the charging mode includes storing excess energy output of the renewable energy source in the battery unit.

In some embodiments, the power management logic is further configured to detect that the energy output associated with the renewable energy source is less than the determined load demand and operate the battery unit in a discharging mode in response to detecting that the energy output is less than the determined load demand, wherein the discharging mode includes releasing energy stored in the battery unit to satisfy the load demand.

In some embodiments, the power management logic is further configured to detect a pricing event associated with the one or more power sources, and control charging and discharging of the battery unit based on the detected pricing event.

In some embodiments, the power management logic is further to detect a power source switchover event associated with the device and operate the battery unit in a discharging mode during the power source switchover event.

In some embodiments, dynamically controlling the power supplied from the one or more PSUs and the battery unit includes operating the one or more PSUs in one of an active mode or a standby mode based on the determined load demand and a PSU efficiency parameter, and operating the battery unit in one of a charging mode, a discharging mode, or an idle mode based on the determined load demand.

In some embodiments, dynamically controlling the power supplied from the one or more PSUs and the battery unit further includes operating at least one of the PSU among the one or more PSUs in an active mode based on the determined load demand, and operating the battery unit in a discharging mode based on the determined load demand.

In some embodiments, the power management logic is further to configured to predict one or more time periods of power unavailability from the one or more power sources, generate a discharging schedule for the battery unit based on the prediction of the one or more time periods of power unavailability, and operate the battery unit in a discharging mode based on the discharging schedule.

In some embodiments, the power management logic predicts the one or more time periods of power unavailability based on at least one of historical power availability data or one or more environmental factors.

In some embodiments, the power management logic is further to configured to generate a charging schedule for the battery unit based on the prediction of the one or more time periods of power unavailability, and operate the battery unit in a charging mode based on the charging schedule.

In some embodiments, the charging schedule is aligned with the one or more time periods of power unavailability to maintain energy reserves in the battery unit for the one or more time periods of power unavailability.

In some embodiments, a device includes a processor, a plurality of power supply unit (PSU) slots including at least a first PSU slot and a second PSU slot, a PSU disposed within the first PSU slot, a battery unit disposed within the second PSU slot, wherein the PSU and the battery unit are configured to supply power to the device, and a memory communicatively coupled to the processor, wherein the memory includes a power management logic that is configured to determine a load demand associated with the device, monitor one or more power sources providing power to the PSU and the battery unit, and dynamically control the power supplied from the PSU and the battery unit based on the determined load demand and the monitored one or more power sources.

In some embodiments, a method includes determining a load demand associated with a network device, wherein the network device includes one or more power supply units (PSUs) and a battery unit disposed within a linecard slot in the network device, monitoring one or more power sources providing power to the battery unit and the one or more PSUs, and dynamically controlling a power supply from the one or more PSUs and the battery unit based on the determined load demand and the monitored one or more power sources.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram of network devices connected to a power supply from a power grid in accordance with various embodiments of the disclosure;

FIG. 2 is a conceptual diagram of a network device having a battery unit disposed within a PSU slot in accordance with various embodiments of the disclosure;

FIG. 3 is a conceptual diagram of a network device having a battery unit disposed within a linecard slot in accordance with various embodiments of the disclosure;

FIG. 4 is a conceptual diagram of a network device having battery units disposed within a linecard slot and a PSU slot in accordance with various embodiments of the disclosure;

FIG. 5 is a conceptual diagram of a plurality of network devices supporting fault managed power (FMP) capability in accordance with various embodiments of the disclosure;

FIG. 6 is a flowchart showing a process for dynamic controlling power supplied from PSUs and battery units of a network device in accordance with various embodiments of the disclosure;

FIG. 7 a flowchart showing a process for grid support functions and renewable energy source power management for a network device in accordance with various embodiments of the disclosure;

FIG. 8 a flowchart showing a process for energy arbitrage in a network device in accordance with various embodiments of the disclosure;

FIG. 9 a flowchart showing a process for utilizing a battery unit to support a power source switchover event of a network device in accordance with various embodiments of the disclosure;

FIG. 10 is a flowchart showing a process for predictive control of a battery unit included in a network device in accordance with various embodiments of the disclosure;

FIG. 11 a flowchart showing a process for power grid load balancing in accordance with various embodiments of the disclosure;

FIG. 12 a flowchart showing a process for different operational modes of a battery unit in accordance with various embodiments of the disclosure; and

FIG. 13 is a conceptual block diagram for one or more devices capable of executing components and logic for implementing the functionality and embodiments is shown in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that employ battery units in network devices to maintain redundancy and uninterrupted power supply. Network devices (for example, routers, servers, switches, or the like) often include one or more power supply units (PSUs) that provide power to the network devices. The PSUs can also provide power to various externally connected devices (such as Internet Protocol (IP) phones, IP cameras, other network devices, or the like), for example, via one or more Power over Ethernet (PoE) ports of the network device. Generally, to manage power fluctuations and to ensure continuous power supply to the network devices (for example, routers, servers, firewalls, or the like), redundant PSUs and hold-up capacitors are used. When redundant PSUs are added to a network device, the PSUs may operate below optimal efficiency range due to load sharing between the PSUs. Thus, preventing any single PSU from reaching its most efficient operating point. Further, duplicating the hold-up capacitors in the PSUs adds to the bulk and takes up valuable space within the PSUs. These solutions pose inefficiency of design and make the network device bulky. Therefore, there is a need to provide an efficient power supply solution for network devices with compact form factor.

The present disclosure presents a solution to overcome above-described issues by providing a network device that includes at least one battery unit disposed within a linecard slot, a PSU slot, a fabric card slot, a fan tray slot, a route processor (RP) slot, or a combination thereof. For example, a network device (for example, routers, switches, hubs, servers, or the like) may have an unused or a legacy linecard, a fabric card, a route processor (RP), or a fan tray, which can be replaced with a battery unit. Similarly, an unused PSU slot in the network device can be used to include a battery unit. Inclusion of the battery unit in the network device can offset the need for redundant components or the hold-up capacitors, resulting in a more compact form factor of the network device.

In a number of embodiments, the battery unit may act as an effective filter that smoothens the variations in power signals, thus, providing a cleaner power supply to connected network equipment. The battery unit may enhance the overall stability of the delivered and reduce the reliance on additional filtering components, thus contributing to a more simplified and cost-effective design. Another advantage of disposing the battery unit in the linecard slot and/or the PSU slot is reduced capacitor requirements, as the battery unit can assist in managing short-term and mid-term power fluctuations.

In several embodiments, the network device may be connected to one or more power sources, for example, a utility power grid, one or more renewable sources of energy (for example, solar energy, wind energy, etc.), or a back-up power generator. In addition to the battery unit disposed within the PSU slot and/or the linecard slot, the network device may also include one or more PSUs that supply power to the network device. For example, the PSUs may draw power from the one or more power sources and supply it to the network device. Further, the battery unit may draw power from the one or more power sources and store energy within one or more charge storage elements of the battery unit. As and when required, the battery unit may supply power based on the stored energy.

In numerous embodiments, each PSU may be operable in one of an active mode or a standby mode. The active mode of a PSU may refer to a state in which the PSU can actively supply power to the network device. During the active mode, the PSU may draw power from the one or more power sources and supply it to the network device. The standby mode of a PSU may refer to a low-power state during which the PSU may still be connected to the one or more power sources but may not actively supply the power. In the standby mode, the PSU may continue to provide a small amount of power to maintain essential functions.

In additional embodiments, the battery unit may be operable in one of a charging mode, a discharging mode, or an idle mode. In the charging mode, the battery unit may draw power from the one or more power sources and store energy within the one or more charge storage elements. In the discharging mode, the battery unit may supply power to the network device based on the energy stored within the one or more charge storage elements. In the idle mode, the battery unit may be neither charging nor discharging. For example, in a scenario where the battery unit is fully charged and is not required to supply power, the battery unit may operate in the idle mode.

In a variety of embodiments, power supply from the one or more PSUs and the battery unit can be dynamically controlled based on a load demand and the one or more power sources coupled to the network device. In further embodiments, the power supply may be dynamically controlled by a power management logic implemented in the network device. The power management logic can be executed by a power controller in the network device or an external monitoring device. The power management logic may dynamically control the PSUs and the battery unit to satisfy the load demand (e.g., internal load and/or external load).

To dynamically control the power supplied from the PSUs and the battery unit, the power management logic may dynamically operate each PSU in one of the active mode or the standby mode and the battery unit in one of the charging mode, the discharging mode, or the idle mode. In an example, a load demand associated with the network device may be too low, resulting in suboptimal operation of the PSUs. In such a scenario, the power management logic may trigger the PSUs to operate in the standby mode and trigger the battery unit to operate in the discharging mode and supply required power to satisfy the load demand. Similarly, in a scenario where the load demand is within a peak efficiency load range, the power management logic may trigger the PSUs to operate in the active mode and trigger the battery unit to operate in the charging mode if the battery unit is not fully charged or in the idle mode if the battery unit is fully charged. In additional scenarios, where the load demand exceeds the peak efficiency load range, the power management logic may operate the PSUs in the active mode and may also trigger the battery unit to operate in the discharging mode to compensate for the excess load demand. As a result, in spite of the load demand exceeding the peak efficiency load range, the PSUs operate within the peak efficiency load range, while the battery unit compensates for the excess load demand.

In more embodiments, where the network device is connected to the utility power grid as one of the power sources, the power management logic may utilize the battery unit to execute one or more gird support functions. For example, the power management logic may utilize the battery unit for frequency regulation, voltage control, or load balancing for the utility power grid. For load balancing, the power management logic may operate the battery unit in one of the charging mode or the discharging mode as per the demand handled by the utility power grid. For example, the power management logic may control the battery unit to store excess energy from the utility power grid during periods of low demand and release the stored energy to the utility power grid during periods of peak demand.

In still more embodiments, battery integration may enable the network device to participate in demand response programs, energy arbitrage, and green charge management. For energy arbitrage, the power management logic may operate the battery unit in one of the charging mode or the discharging mode as per a pricing event associated with the one or more power sources. For example, the power management logic may dynamically control the battery unit to operate in the charging mode during periods of low electricity prices and in the discharging mode during period of high electricity prices, potentially leading to cost savings. For green charge management, the power management logic may operate the battery unit in one of the charging mode or the discharging mode as per whether the one or more power sources are providing green energy or non-green energy. For example, the power management logic may dynamically control the battery unit to operate in the charging mode during periods when green energy is available and in the discharging mode during periods when green energy is unavailable. Consequently, the stored energy in the battery unit may reduce power supply demand from the power sources during periods of non-green energy, potentially leading to reduced carbon-footprint.

In several embodiments, the power management logic may further predict one or more time periods of power unavailability from the one or more power sources. For example, if the network device is coupled to a solar power source. The power management logic may refer to weather predictions, environmental data, or the like and predict a time period during which the solar power would be unavailable. The power management logic may generate charging and discharging schedules for the battery unit based on the prediction of the one or more time periods of power unavailability and operate the battery unit in the charging mode and the discharging mode as per the generated schedules. Such predictive management facilitates uninterrupted power supply to the network device by utilizing the battery unit.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

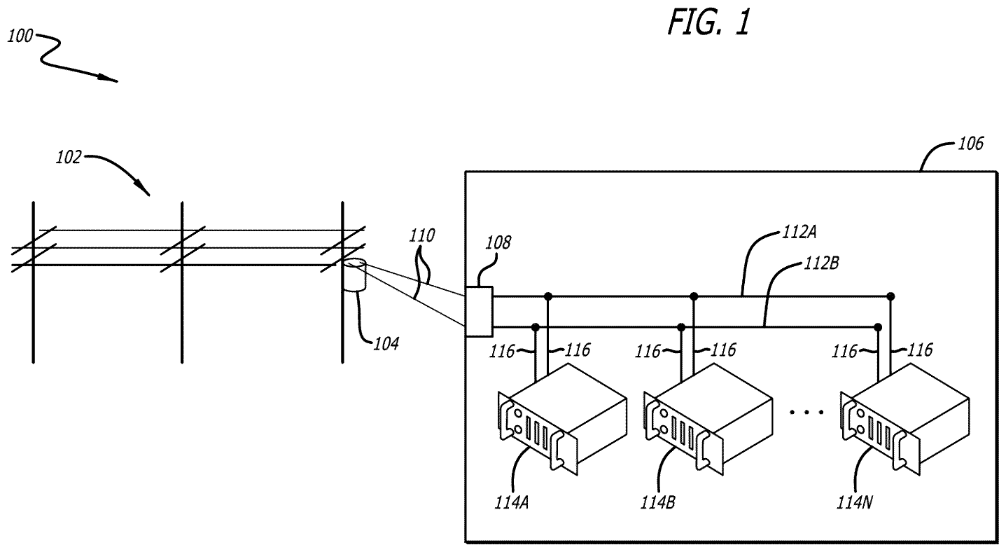

Referring to FIG. 1, a conceptual diagram 100 of network devices connected to a power supply from a power grid in accordance with various embodiments of the disclosure is shown. In many embodiments, a three-phase power can be distributed across a power distribution network through a power grid 102. In a number of embodiments, the power grid 102 may include a transformer 104. In an example, the transformer 104 can be a step-down transformer, which steps the voltage of two or more of the phases down to a voltage level useable for a power mains 108 in a building 106. The stepped down voltages provided by the transformer 104 are denoted as “stepped down voltages 110”. In a variety of embodiments, the building 106 may have network devices 114A-114N. The network devices 114A-114N may be electrically connected to the power mains 108 through one or more power lines 112A, 112B.

In still yet more embodiments, the power grid 102 in power distribution network may be run through a public utility network and/or may be run through a private distribution network supplied by a private cogeneration facility. In more embodiments, the power mains 108 may include a circuit breaker that disconnects the stepped down voltages 110 from the power lines 112A, 112B in an event that current flowing from the stepped down voltages 110 becomes larger than a critical threshold value. In additional embodiments, the network devices 114A-114N may be configured with multiple power outlets 116 to connect to the power lines 112A, 112B. Each power outlet 116 may connect to a separate power supply unit (PSU) in each network device 114A-114N with at least one of the power outlets 116 connecting to a battery unit disposed within each network device 114A-114N.

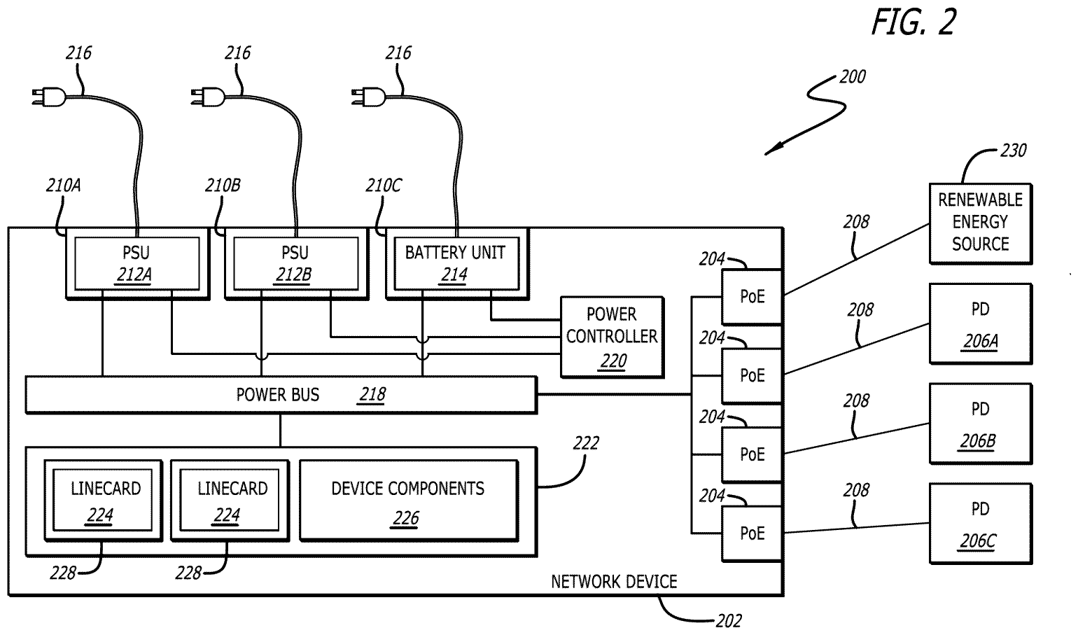

Although a specific embodiment for network devices connected to a power supply from a power grid suitable for carrying out the various steps, processes, methods, and operations described herein is discussed with respect to FIG. 1, any of a variety of systems and/or processes may be utilized in accordance with embodiments of the disclosure. In still more embodiments, the stepped down voltages 110 may also be supplied from a source independent from the power grid 102. For example, the stepped down voltages 110 can be supplied through a back-up power generator, a private power generator, one or more renewable sources of energy, of the like. The elements depicted in FIG. 1 may also be interchangeable with other elements of FIGS. 2-13 as required to realize a particularly desired embodiment.

Referring to FIG. 2, a conceptual diagram 200 of a network device having a battery unit disposed within a PSU slot in accordance with various embodiments of the disclosure is shown. The embodiments depicted in the conceptual diagram 200 may show a scenario where a network device 202 (such as a router, server, switch, a hub, or the like) may include a plurality of Power over Ethernet (POE) ports 204. In some examples, the PoE ports 204 can be unidirectional and may transmit power to a connected device. In additional examples, the PoE ports 204 can be bidirectional, and thus may transmit as well as receive power from the connected device. In many embodiments, the plurality of PoE ports 204 (collectively, “PoE ports 204”) may be operable to transmit power to one or more Powered Devices (PD) (for example, PDs 206A, 206B, 206C) connected to the PoE ports 204 via Ethernet cables 208. For example, the PoE ports 204 may be configured to transmit PoE to any number or type of PDs, such as Internet Protocol (IP) phones, televisions, HVAC controls, charging stations, cameras, or the like. Similarly, in a number of embodiments, the bi-directional PoE ports 204 may also be connected to a renewable energy source 230, for example, solar energy, wind energy, or the like, to receive power.

In a variety of embodiments, the network device 202 may further include a plurality of PSU slots 210A, 210B, 210C. As depicted in FIG. 2, the PSU slots 210A, 210B carry PSUs 212A, 212B, respectively. In still yet more embodiments, one or more PSU slots of the network device 202 may have one or more battery units disposed within. For example, as shown in FIG. 2, the PSU slot 210C may have a battery unit 214 disposed within. The PSUs 212A, 212B and the battery unit 214 may each be connected to an electrical plug 216 that connects to an electrical socket for power supply, for example, from a power grid, a power generator, or any other power source. In more embodiments, the network device 202 may further include various functional electronic modules 222. The functional electronic modules 222 may include linecards 224 disposed within linecard slots 228. The linecards 224 may provide network interfaces to connect the network device 202 (such as a router, server, etc.) to other network devices and links. The functional electronic modules 222 may further include other device components 226 such as processors, memory, network interface controllers, or the like. In several embodiments, the network device 202 may include one or more fabric card slots, one or more route processor (RP) slots, or one or more fan tray slots. In still several embodiments, one or more battery units may be disposed within the one or more fabric card slots, the one or more route processor (RP) slots, or the one or more fan tray slots.

In additional embodiments, the PSUs 212A, 212B and the battery unit 214 may supply power to the functional electronic modules 222 and the PoE ports 204 via a power bus 218. The power bus 218 may refer to a system of electrical conductors or traces designed for distributing electrical power to various components within the network device 202. The power bus 218 may distribute different voltage levels required by different components, such as 3.3V, 5V, 12V, etc.

In numerous embodiments, each of the PSUs 212A, 212B may operate in one of an active mode or a standby mode. During the active mode, a PSU (e.g., any of the PSUs 212A, 212B) may draw power from one or more power sources (e.g., the power grid, the power generator, the renewable energy source 230, non-renewable energy source, or the like) and supply it to the various components within the network device 202 and to the one or more PDs 206A, 206B, 206C via the PoE ports 204. The active mode, may therefore, refer to a mode in which the PSUs 212A, 212B may supply power to the network device 202 for its operations. In the standby mode, a PSU (e.g., any of the PSUs 212A, 212B) may be in a low-power state during which the PSU may still be connected to the one or more power sources but may not actively supply the power. In numerous additional embodiments, in the standby mode, the PSUs 212A, 212B may continue to provide a small amount of power to maintain essential functions of the network device 202.

In further additional embodiments, the battery unit 214 may operate in one of a charging mode, a discharging mode, or an idle mode. In the charging mode, the battery unit 214 may draw power from the one or more power sources and store energy within one or more charge storage elements. In the discharging mode, the battery unit 214 may supply power to various components within the network device 202 based on the energy stored within the one or more charge storage elements. In further additional embodiments, the battery unit 214 may also supply power to the one or more PDs 206A, 206B, 206C via the PoE ports 204 during the discharging mode. In the idle mode, the battery unit 214 may neither be charging nor supplying power. For example, when the battery unit 214 is fully charged and may not be required to supply power, the battery unit 214 may operate in the idle mode.

In further embodiments, the network device 202 may also include a power controller 220. The power controller 220 may include suitable circuitry, logic, or interface to facilitate one or more operations to dynamically control the power supplied from the PSUs 212A, 212B and the battery unit 214. Examples of the power controller 220 may include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), a Digital Signal Processor (DSP), or the like.

In several embodiments, the power controller 220 may determine a load demand associated with the network device 202. The load demand may refer to an amount of power required by the internal components (such as processors, memory, network interface controllers, etc.) of the network device 202 and/or power required by the one or more PDs 206A, 206B, 206C connected to the network device 202 at any given point in time. For example, the power controller 220 may determine that during weekdays between 2:00 PM-4:00 PM IP phones draw power from the network device 202 along with the other internal components of the network device 202. The amount of power drawn by the IP phones and the other internal components between 2:00 PM-4:00 PM may refer to the load demand between 2:00 PM-4:00 PM.

In numerous embodiments, the power controller 220 may monitor one or more power sources providing power to the PSUs 212A, 212B and the battery unit 214. The one or more power sources may include, for example, the utility power grid, the renewable energy source, the power generator, and/or the non-renewable energy source. Examples of the renewable energy sources may include, but are not limited to, wind energy, solar energy, or any other type of green energy source. Examples of the non-renewable energy source may include, but are not limited to, power sources that generate power from fossil fuels, nuclear fuels, or the like. The power controller 220 may thus monitor the amount of power supplied, time periods of power supply, pricing event associated with the power supply, and other parameters of the one or more power sources.

In numerous additional embodiments, the power controller 220 may dynamically control the power supplied from the PSUs 212A, 212B and the battery unit 214 based on the determined load demand and the monitored one or more power sources. The power controller 220 may, thus, dynamically select any of the PSUs 212A, 212B, the battery unit 214, the renewable energy source 230, or a combination thereof to supply power to satisfy the determined load demand. In many further embodiments, the power controller 220 may determine whether the battery unit 214 needs to be charged, discharged, or to be in the idle mode based on the determined load demand. In several embodiments, the power controller 220 may dynamically control the PSUs 212A, 212B to operate in the active mode or the standby mode based on the determined load demand and a PSU efficiency parameter. The efficiency of a PSU is a measure of how effectively the PSU converts electrical power from the source (usually AC from the wall outlet) to the power required by the components (DC). Thus, the PSU efficiency parameter may refer to how effectively a PSU can convert electrical power from the source (usually AC from the wall outlet) to the power required by the network device 202 and/or the PDs 206A, 206B, 206C. In a similar manner, the power controller 220 may operate at least one of the PSU from among the PSUs 212A, 212B in the active mode and operate the battery unit 214 in a discharging mode based on the determined load demand.

In still more embodiments, in response to the network device 202 being connected to the power grid, the power controller 220 may support one or more grid support functions via the battery unit 214. Examples of the grid support functions may include, but are not limited to, frequency regulation, voltage control, load balancing, or the like. For example, the power controller 220 may control the battery unit 214 to charge or discharge in a controlled manner to maintain the grid frequency within a defined range, for example, around a nominal value (e.g. 60 Hz or 50 Hz) as well as the voltage levels within the desired limits. Further, the power controller 220 may determine periods of low demand associated with the power grid and may operate the battery unit 214 in the charging mode to store excess energy available at the power grid. Similarly, the power controller 220 may determine periods of peak demand associated with the power grid and may operate the battery unit 214 in the discharging mode to release the stored energy. Thus, the battery unit 214 can be dynamically configured to store or release the energy depending upon the demand, thus balancing the load on the power grid.

In still additional embodiments, the power controller 220 may be configured to integrate power from one or more renewable energy sources, e.g., the renewable energy source 230. The power controller 220 may utilize the battery unit 214 as an energy buffer, storing excess energy when production from the one or more renewable energy sources exceeds the load demand. The power controller 220 may also dynamically control the battery unit 214 to release the stored energy during periods of high load demand or low renewable energy generation by the one or more renewable energy sources.

In some more embodiments, usage of the battery unit 214 in the network device 202 may enable the network device 202 to participate in demand response programs. Demand response programs may refer to a strategy implemented by grid operators to manage electricity consumption during periods of high demand or supply constraints. It can incentivize customers to temporarily reduce electricity usage during peak periods, providing the grid operators with a flexible resource to balance supply and demand. The power controller 220 may receive signals from the power grid to either draw power or reduce power consumption. Thus, the power controller 220 may dynamically control the PSUs 212A, 212B and the battery unit 214 based on the signals received from the power grid.

Further, the power controller 220 may operate the battery unit 214 in the charging mode during periods of low electricity prices and the discharging mode during periods of high electricity prices. For example, electricity prices can be high during the day and can be low during the night. In such a scenario, the power controller 220 may control the battery unit 214 to supply power during the day and utilize the PSUs 212A, 212B to supply power to meet load demand surge or if utilizing the battery unit 214 reduces the overall efficiency of the network device 202. Further, the power controller 220 may control the battery unit 214 to charge during the night when prices are low and utilize the PSUs 212A, 212B to supply power to satisfy the load demand during the night. The power controller 220 can thus lead to potential cost savings by dynamically controlling charging/discharging of the battery unit 214 based on pricing events. In other words, the power controller 220 may dynamically control power supplied from a combination of the PSUs 212A, 212B, the renewable energy source 230, and the battery unit 214 based on a current load demand, time of day, electricity pricing, green/non-green-energy indication, power outages at the power grid, or the like.

In yet more embodiments, the power controller 220 may use a machine learning (ML) model that can detect patterns or make predictions. In an example scenario, based on past data or historical trends, the ML model utilized by the power controller 220 may learn that a combination of the renewable energy source 230 and the battery unit 214 showcases peak efficiency between 10:00 AM-12:00 Noon. Therefore, the power controller 220 may operate the PSUs 212A, 212B in the standby mode and supply the power from the renewable energy source 230 and the battery unit 214 during 10:00 AM-12:00 Noon.

Although a specific embodiment for a network device having a battery unit disposed within a PSU slot suitable for carrying out the various steps, processes, methods, and operations described herein is discussed with respect to FIG. 2, any of a variety of systems and/or processes may be utilized in accordance with embodiments of the disclosure. In many further embodiments, the renewable energy source 230 may be a part of the network device 202. For example, a solar panel may be placed on an outer casing or chassis of the network device 202 and can be used to charge the battery unit 214. The elements depicted in FIG. 2 may also be interchangeable with other elements of FIGS. 1 and 3-13 as required to realize a particularly desired embodiment.

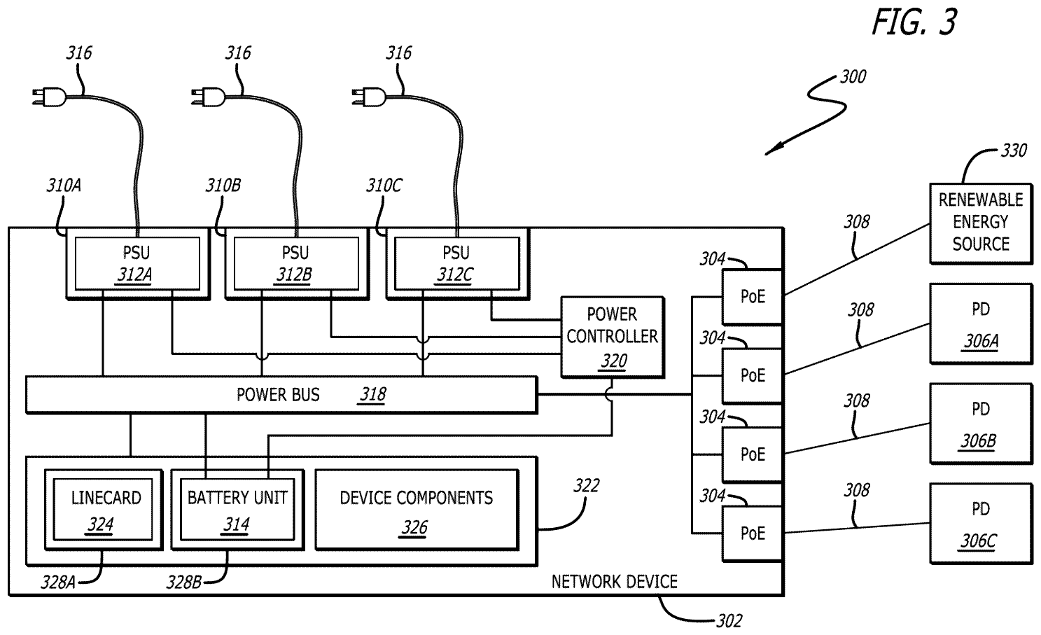

Referring to FIG. 3, a conceptual diagram 300 of a network device having a battery unit disposed within a linecard slot in accordance with various embodiments of the disclosure is shown. The embodiments depicted in the conceptual diagram 300 may show a scenario where a network device 302 may have a plurality of PoE ports 304. The plurality of PoE ports 304 can be unidirectional or bidirectional. In many embodiments, the plurality of PoE ports 304 may be operable to transmit power to PDs 306A, 306B, 306C, via Ethernet cables 308. Similarly, in a number of embodiments, the bi-directional PoE ports 304 may also be connected to a renewable energy source 330, such as solar energy, wind energy, or the like, to receive power.

In a variety of embodiments, the network device 302 may include a plurality of PSU slots 310A, 310B, 310C. Each PSU slot may have a PSU 312A, 312B, 312C disposed within. The PSUs 312A, 312B, 312C may be connected to electrical plugs 316 that connect to an electrical socket for power supply, for example, from a power grid, a power generator, or any other power source. In more embodiments, the network device 302 may include various functional electronic modules 322. The functional electronic modules 322 may include a linecard 324 disposed within a linecard slot 328A and a battery unit 314 disposed within another linecard slot 328B. The linecard 324 may provide network interface to connect the network device 302 (such as a router, server, etc.) to other network devices and links. The battery unit 314 may be charged, for example, via the renewable energy source 330 or other power sources. The functional electronic modules 322 may further include other device components 326 such as processors, memory, network interface controllers, or the like.

In additional embodiments, the PSUs 312A, 312B, 312C and the battery unit 314 may supply power to various components of the network device 302, such as the linecards 324, the device components 326, the plurality of PoE ports 304, or the like via a power bus 318. The power bus 318 may distribute electrical power to various components within the network device 302. In further embodiments, the network device 302 may also include a power controller 320. The power controller 320 may include suitable circuitry, logic, or interface to facilitate one or more operations to dynamically control the power supplied from the PSUs 312A, 312B, 312C, and the battery unit 314. Examples of the power controller 320 may include, but are not limited to, an ASIC processor, a RISC processor, a CISC processor, an FPGA, a DSP, or the like. The power controller 320 may dynamically control the power supplied from the PSUs 312A, 312B, 312C and the battery unit 314. In further embodiments, the power controller 320 may dynamically control the supply of power from the PSUs 312A, 312B, 312C, and the battery unit 314 based on requirements for load balancing for the grid, demand response and energy arbitrage, integration of renewable energy, frequency regulation, voltage control, maintaining efficiency of the PSUs 312A, 312B, 312C, or the like.

Although a specific embodiment for a network device having a battery unit disposed within a linecard slot suitable for carrying out the various steps, processes, methods, and operations described herein is discussed with respect to FIG. 3, any of a variety of systems and/or processes may be utilized in accordance with embodiments of the disclosure. For example, in further embodiments, the battery unit 314 may be connected to the electrical plug 316 to receive power from the power grid or other power sources. The elements depicted in FIG. 3 may also be interchangeable with other elements of FIGS. 1-2 and 4-13 as required to realize a particularly desired embodiment.

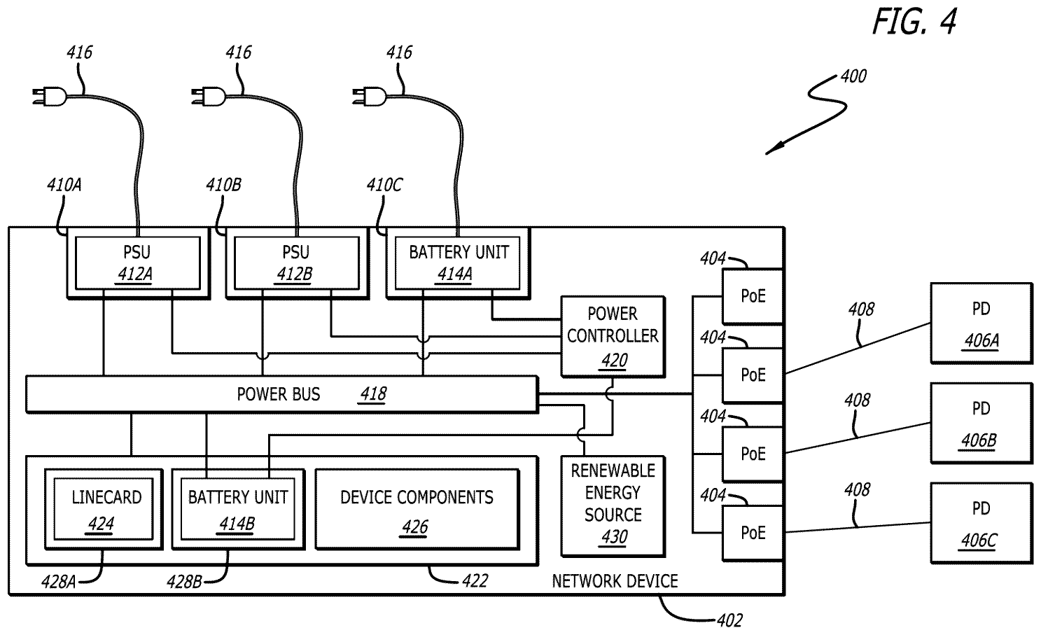

Referring to FIG. 4, a conceptual diagram 400 of a network device having battery units disposed within a linecard slot and a PSU slot in accordance with various embodiments of the disclosure is shown. In many embodiments, the conceptual diagram 400 may show a scenario where a network device 402 may have a plurality of PoE ports 404. The PoE ports 404 can be unidirectional or bidirectional. In a number of embodiments, a plurality of PoE ports 404 may be operable to transmit power to PD 406A, 406B, 406C, via Ethernet cables 408.

In a variety of embodiments, the network device 402 may include a plurality of PSU slots 410A, 410B, 410C, The PSU slots 410A, 410B may have respective PSUs 412A, 412B disposed within. The PSU slot 410C may have a battery unit 414A installed within. The PSUs 412A, 412B, and the battery unit 414A may each be connected to an electrical plug 416 that connects to an electrical socket for power supply, for example, from a power grid, a power generator, or any other power source. In more embodiments, the network device 402 may further include various functional electronic modules 422. The functional electronic modules 422 may include a linecard 424 disposed within a linecard slot 428A and a battery unit 414B disposed within another linecard slot 428B. The linecard 424 may provide network interfaces to connect the network device 402 (such as a router, server, etc.) to other network devices and links. The functional electronic modules 422 may further include other device components 426 such as processors, memory, network interface controllers, or the like.

In additional embodiments, the PSUs 412A, 412B and the battery units 414A, 414B may supply power to various components of the network device 402 via a power bus 418. The power bus 418 may distribute electrical power to various components within the network device 402. In further embodiments, the network device 402 may also include a renewable energy source 430 within the network device 402. For example, the renewable energy source 430 can be a solar panel embedded within the casing of the network device 402 to generate renewable energy.

In still more embodiments, the network device 402 may include a power controller 420 configured to dynamically control the power supplied from the PSUs 412A, 412B and the battery units 414A, 414B. Examples of the power controller 420 may include, but are not limited to, an ASIC processor, a RISC processor, a CISC processor, an FPGA, a DSP, or the like. In still further embodiments, the power controller 420 may dynamically control the supply of power from a combination of one or more PSUs 412A, 412B and one or more battery units 414A, 414B to optimize an overall energy efficiency of the network device 402. For example, the power controller 420 may determine that supplying power only from the PSUs 412A, 412B may result in overall decreased energy efficiency at maximum load demand. However, when power is supplied by the PSUs 412A, 412B and the battery unit 414A, the energy efficiency improves. In such a scenario, in response to the load demand being the maximum load demand, the power controller 420 may dynamically control the PSUs 412A, 412B in an active mode and the battery unit 414A in a discharging mode to supply power. The other battery unit 414B can be maintained in a charging mode or an idle mode.

In still yet more embodiments, the battery units 414A, 414B may contribute to smoothing out power fluctuations and thus improving the power quality. In yet more embodiments, the power controller 420 may dynamically control the battery units 414A, 414B in the charging mode to provide backup power during power outage. Further, the power controller 420 may operate the battery units 414A, 414B in the charging mode to support during a switchover between a primary power source and a secondary power source, thus ensuring continuous power supply to the network device 402.

Although a specific embodiment for a network device having battery units disposed within a linecard slot and a PSU slot suitable for carrying out the various steps, processes, methods, and operations described herein is discussed with respect to FIG. 4, any of a variety of systems and/or processes may be utilized in accordance with embodiments of the disclosure. For example, in yet more embodiments, the power controller 420 may utilize an ML model to predict a load demand and accordingly operate the PSUs 412A, 412B, the battery units 414A, 414B, and the renewable energy source 430. The ML model may learn trends related to various parameters such as electricity pricing, load balancing, voltage fluctuations, time of the day, or the like to make the predictions for power supply. For example, based on historical records, the ML model may predict periods when the electricity prices may be low or negative, such as off-peak hours (between 11:00 PM-5:00 AM), weekends, seasonal variations such as spring and fall that require reduced heating/cooling needs. The ML model may thus operate the PSUs 412A, 412B in an active mode during the low or negative electricity pricing period. The elements depicted in FIG. 4 may also be interchangeable with other elements of FIGS. 1-3 and 5-13 as required to realize a particularly desired embodiment.

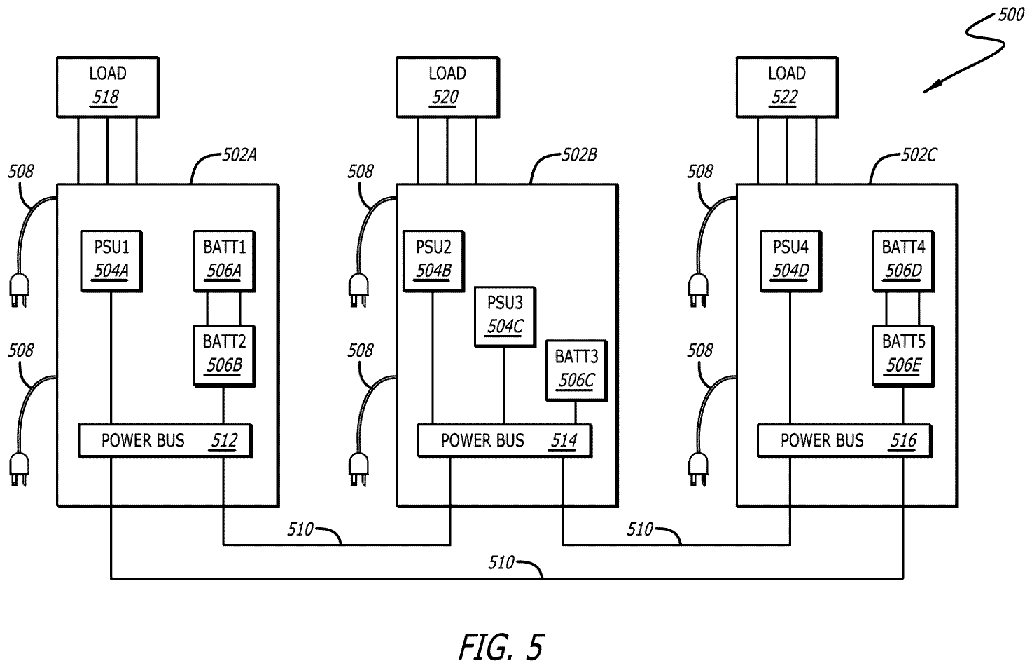

Referring to FIG. 5, a conceptual diagram 500 of a plurality of network devices supporting fault managed power (FMP) capability in accordance with various embodiments of the disclosure is shown. In many embodiments, the conceptual diagram 500 depicts first through third network devices 502A, 502B, 502C. Examples of the first through third of network devices 502A, 502B, 502C may include, but are not limited to, routers, switches, hubs, servers, or other such networking equipment. In a variety of embodiments, the first through third network devices 502A, 502B, 502C may be connected to an electrical power supply via electrical plugs 508.

In number of embodiments, the first network device 502A may include one PSU “PSU1” 504A and two battery units “BATT1” 506A and “BATT2” 506B. The PSU1 504A, BATT1 506A, and BATT2 506B may supply power to various components of the first network device 502A via a power bus 512. The first network device 502A may also be connected to a load 518. In still yet more embodiments, the load 518 may refer to an external load such as Internet Protocol (IP) Phone, IP Cameras, VoIP Phones, Internet of Things (IoT) devices, LED lightings, or the like connected to the first network device 502A.

In a similar manner, in more embodiments, the second network device 502B may include two PSUs “PSU2” 504B, “PSU3” 504C, and one battery unit “BATT3” 506C. The PSU2 504B, PSU3 504C, and BATT3 506C may supply power to various components of the second network device 502B via a power bus 514. The second network device 502B may also be connected to a load 520. In additional embodiments, the third network device 502C may include one PSU “PSU4” 504D, two battery units “BATT4” 506D, “BATT5” 506E. The PSU4 504D, BATT4 506D, BATT5 506E may supply power to various components of the third network device 502C by a power bus 516. Additionally, the third network device 502C may also be connected to a load 522.

In still more embodiments, the first through third network devices 502A, 502B, and 502C may be connected to each other via one or more FMP ports and Ethernet cables 510. FMP or Extended Safe Power (ESP) system may be utilized to transmit and receive power or power and data. In still more embodiments, the FMP may be utilized to transmit or receive high power (e.g., >100 W), high voltage (e.g., ≥56V) with pulse power delivered on one or more wires or wire pairs. In still further embodiments, the FMP may incorporate fault management capabilities to detect, isolate, and mitigate faults or abnormalities within a power supply network. In an example scenario, the power supply to the first network device 502A may suffer a fault and may be unable to provide power to the load 518. For example, the “BATT1” 506A and “BATT2” 506B may not be charged and the power source may suffer an outage, rendering the PSU1 504 also inoperable. In such scenario, the FMP ports of the first network device 502A may receive power from the connected second and third network devices 502B and 502C and operations of the first network device 502A may continue without interruption.

Although a specific embodiment for a plurality of network devices supporting FMP capability suitable for carrying out the various steps, processes, methods, and operations described herein is discussed with respect to FIG. 5, any of a variety of systems and/or processes may be utilized in accordance with embodiments of the disclosure. For example, in yet more embodiments, the FMP ports can be implemented using PoE ports. The elements depicted in FIG. 5 may also be interchangeable with other elements of FIGS. 1-4 and 6-13 as required to realize a particularly desired embodiment.

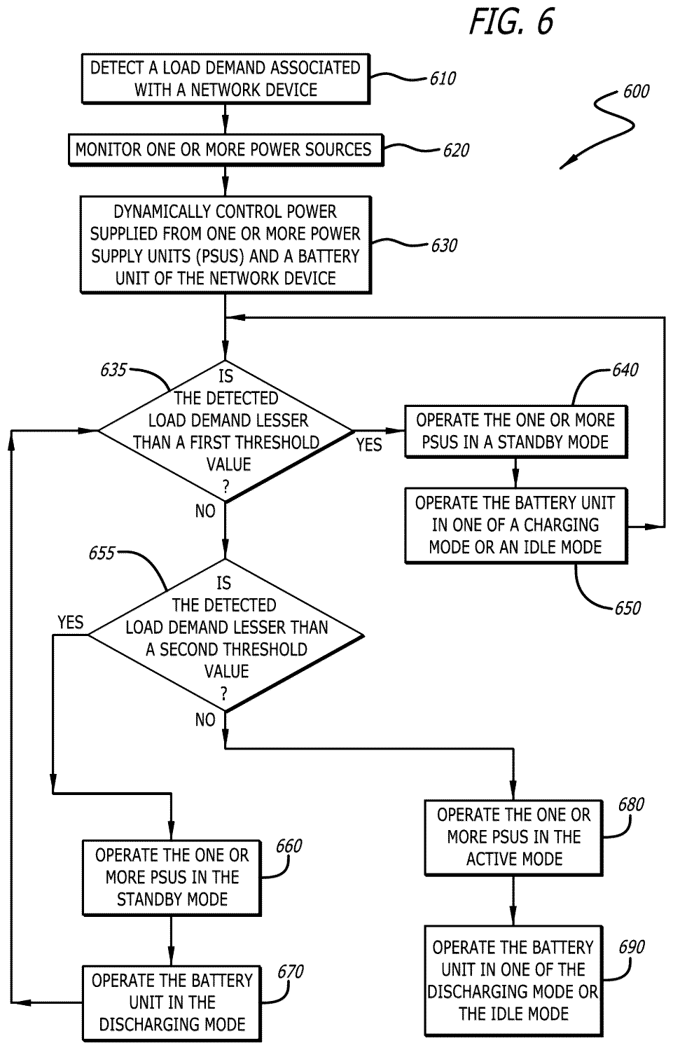

Referring to FIG. 6, a flowchart showing a process 600 for dynamic controlling power supplied from PSUs and battery units of a network device in accordance with various embodiments of the disclosure is shown. In many embodiments, the process 600 may detect a load demand associated with a network device (block 610). The network device may be any of the networking equipment such as a router, a switch, a hub, an access point, a server in a data center, or the like. The network device may include various internal components such as memory, microprocessors, serial ports, Universal Serial Bus (USB) ports, console ports, and other internal circuitry. In numerous embodiments, the network device may also be capable of providing power to external devices such as Internet Protocol (IP) Phone, IP Cameras, VoIP Phones, Internet of Things (IoT) devices, LED lightings, or the like, referred to as Powered Devices (PD), using Power over Ethernet (POE). In a number of embodiments, the process 600 may detect an amount of power required by the internal components or the external devices, which may refer to the load demand.

In a variety of embodiments, the process 600 may monitor one or more power sources (block 620). The power sources may include, for example, a utility power grid, a renewable energy source, or a non-renewable energy source. The renewable energy sources may be wind energy, solar energy, or any other type of green energy source. The one or more power sources may be connected to the network device. The process 600 may monitor the amount of power being supplied by the utility power grid, the renewable energy sources, or the like.

In more embodiments, the process 600 may dynamically control power supplied from one or more PSUs and a battery unit of the network device (block 630). The battery unit may be disposed within a PSU slot or a linecard slot. In many examples, the network device may include multiple battery units disposed within one or more PSU slots, one or more linecard slots, or a combination thereof. The process 600 may dynamically control the power supplied from the one or more PSUs and the battery unit based on the detected load demand and the monitored one or more power sources. The process 600 may detect the load demand and accordingly select which of the one or more PSUs or the battery unit can be utilized to supply power in an efficient manner.

In additional embodiments, the process 600 may determine whether the detected load demand is less than a first threshold value (block 635). The load demand being less than the first threshold value may indicate that the power required by the network device or by the external powered device is very low. In other words, the first threshold value may refer to a low power state or sleep state of the network device or the external powered devices. In the low power state, the network device may only require power to maintain minimal functionality.

If the process 600 determines that the detected load demand is less than the first threshold value, the process 600 may operate the one or more PSUs in the standby mode (block 640). In the standby mode, a PSU may reduce its power output to a minimum level while remaining operational and ready to provide power when needed. In the standby mode, the PSUs operate in low-power state where the PSUs may provide minimal power to certain components of the network device while the main functions may be turned off.

In further embodiments, the process 600 may also operate the battery unit in one of a charging mode or an idle mode (block 650). Since the detected load demand is less than the first threshold value, which may indicate that the power from the PSUs or the battery unit may only be required to power essential components of the network device in a sleep state or a low power state. In this case, since the battery unit may not be required to actively supply power, the process 600 can operate the battery unit in the charging mode to replenish the energy or if the battery unit is already charged, the process 600 may operate the battery unit in the idle mode.

In still more embodiments, if the detected load demand is greater than the first threshold value, the process 600 may operate the one or more PSUs in the standby mode (block 660). However, in still further embodiments, the process 600 may operate the battery unit in the discharging mode (block 670). The battery unit may discharge to provide power to the network device components or to an external device based on the detected load demand which is greater than the first threshold value. The detected load demand being greater than the first threshold may indicate an active load that may consume electrical power. In this situation, the detected load may be easily supported by power from the battery unit and maintaining the required efficiency parameter of the PSUs.

In still additional embodiments, the process 600 may determine whether the detected load demand is less than a second threshold value (block 655). The detected load demand being less than the second threshold value may refer to the load demand being greater than the normal wake conditions load demand, but less than the load demand during power intensive functions. In this situation, various internal components of the network device as well as the external device may be consuming power. For example, the processors of the network device may be processing data packets for routing. In another example scenario, the external device such as an IP Phone may be actively running communication session in power intensive function.

If the load demand is less than the second threshold value, in some more embodiments, the process 600 may operate the one or more PSUs in the standby mode (block 660). Further, the process 600 may operate the battery unit in the discharging mode (block 670). The process 600 may determine that supplying the power via the battery unit may be more power efficient than supplying the power via the one or more PSUs. For example, the load demand that is less than the second threshold value may be less than a peak efficiency load range associated with the PSUs.

However, in yet more embodiments, if the detected load demand is greater than the second threshold value, the process 600 may operate the one or more PSUs in the active mode (block 680). In the active mode, the PSUs may be actively supplying power to the detected load. For example, the PSUs may convert and regulate input power from the power supply sources (such as AC mains) into the required output voltage(s) and current(s) to meet the load demand. In numerous embodiments, the process 600 may determine that when the detected load demand is greater than the second threshold value, operating the one or more PSUs may result in the peak efficiency of the one or more PSUs.

In still yet more embodiments, the process 600 may operate the battery unit in one of the discharging mode or the idle mode (block 690). The process 600 may operate the battery unit in the discharging mode when the detected load demand is greater than the peak efficiency load range of the one or more PSUs. The battery unit, operating in the discharging mode, may satisfy the excess load demand, ensuring that the one or more PSUs operate within the peak efficiency load range. In many further embodiments, the detected load demand may be met by supplying power from the one or more PSUs itself, and thus the battery unit can be operated in the idle mode. In the idle mode, the battery unit may not be supplying power to load.

Although a specific embodiment for dynamic controlling power supplied from PSUs and battery units of a network device suitable for carrying out the various steps, processes, methods, and operations described herein is discussed with respect to FIG. 6, any of a variety of systems and/or processes may be utilized in accordance with embodiments of the disclosure. For example, in several embodiments, the process 600 may dynamically select the battery unit and the one or more renewable energy sources to supply the power, when the detected load demand is greater than the second threshold value. For example, the process 600 may determine that a combination of the battery unit and the one or more renewable energy sources may satisfy the load demand in an efficient manner, without operating the one or more PSUs in the active mode. The elements depicted in FIG. 6 may also be interchangeable with other elements of FIGS. 1-5 and 7-13 as required to realize a particularly desired embodiment.

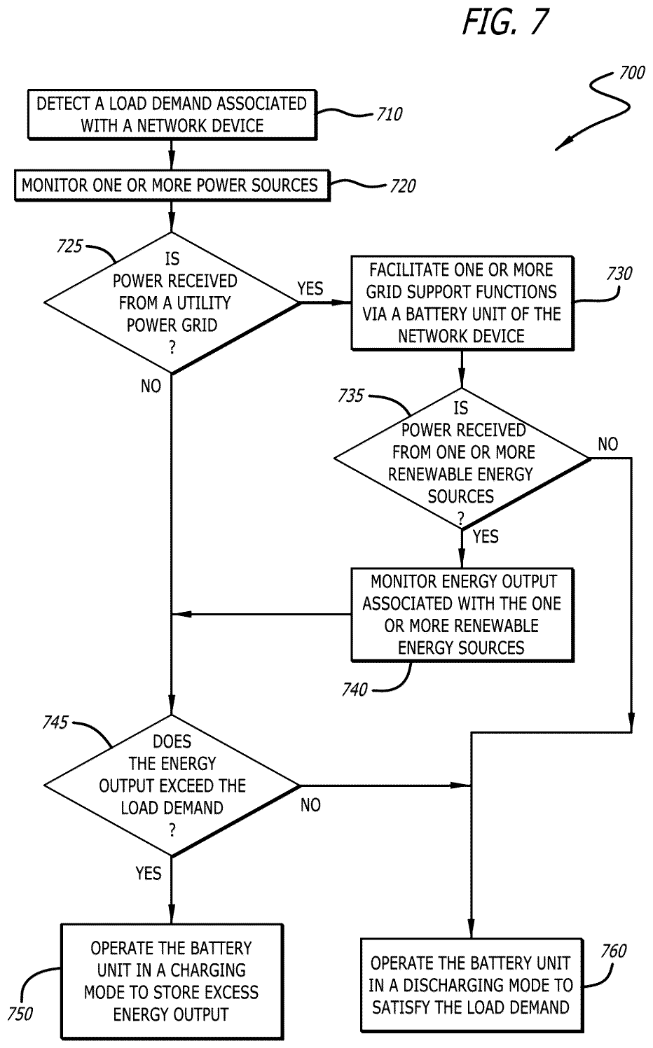

Referring to FIG. 7, a flowchart showing a process 700 for grid support functions and renewable energy source power management for a network device in accordance with various embodiments of the disclosure is shown. In many embodiments, the process 700 may detect a load demand associated with a network device (block 710). The load demand may refer to an amount of power required to power various device components or external devices connected to the network device. For example, at a given time, an external IP camera connected to the network device may require power while the internal components of the network device may be in a sleep state. Thus, in such a scenario, the process 700 may detect the amount of power required by the IP camera as the load demand.

In a number of embodiments, the process 700 may monitor one or more power sources (block 720). The power sources may include, for example, a utility power grid, one or more renewable energy sources, or one or more non-renewable energy source connected to the network device. The renewable energy sources can include wind energy, solar energy, or any other type of green energy source. The process 700 may monitor the amount of power being supplied by the utility power grid, the one or more renewable energy sources, or the like.

In a variety of embodiments, the process 700 may determine whether power is received from the utility power grid (block 725). In numerous embodiments, the utility power grid may utilize one or more non-renewable sources or renewable sources to generate power. If the process 700 determines that the power is received from the utility power grid, in more embodiments, the process 700 may facilitate one or more grid support functions via the battery unit of the network device (block 730). The one or more grid support functions may include frequency regulation, voltage control, or load balancing for the utility power grid. The process 700 may control the battery unit to charge or discharge in a controlled manner to maintain the grid frequency within a defined range, for example, around a nominal value (e.g. 60 Hz or 50 Hz) as well as the voltage levels within the desired limits. For example, if the grid frequency deviates from the nominal frequency, the process 700 may operate the battery unit to correct the deviation. If the grid frequency decreases below the nominal frequency, thus indicating excess demand, the process 700 may operate the battery unit to discharge stored energy to supply additional power to the grid, thereby raising the frequency. Conversely, if the frequency increases above the nominal frequency, thereby indicating excess supply, the process 700 may operate the battery unit to absorb excess power from the grid by charging, thus lowering the frequency. This way the battery unit may help maintain the grid stability and reliability. Thus, the process 700 can operate the battery unit dynamically to store or release the energy depending upon the demand, thus balancing the load on the power grid.

In more embodiments, the process 700 may determine that the power is not received from the utility power grid, and instead may be received from one or more renewable energy sources (block 735). The one or more renewable energy sources may include, for example, solar energy, wind energy, or other sources of green energy. In additional embodiments, the one or more renewable energy sources may be connected to the network device to supply the power. For example, the network device may be connected to one or more solar panels installed in a building in which the network device resides. In further embodiments, the one or more renewable energy sources may be installed on the network device. In various example scenarios, the solar panel may be a part of the network device such that the solar panel can be fitted on the casing of the network device to provide the power.

In still more embodiments, the process 700 may monitor an energy output associated with the one or more renewable energy sources (block 740). The process 700 may track the amount of energy being generated by the one or more renewable energy sources. In numerous embodiments, the process 700 may detect power received at one or more PoE ports of the network device that are coupled to the one or more renewable energy sources to monitor the energy output of the one or more renewable energy sources. In still further embodiments, the process 700 may determine whether the energy output exceeds the load demand (block 745). For example, the process may compare the energy output with the detected load demand and determine whether the energy output is greater than the load demand.

If the energy output exceeds the load demand, in still additional embodiments, the process 700 may operate the battery unit in the charging mode to store excess energy output (block 750). The process 700 may send an instruction to the battery unit to operate in the charging mode in response to determining that the one or more renewable energy sources are producing additional energy. This additional energy may be thus stored by the battery unit to be used later, when the power from the utility power grid may be either expensive or insufficient. In scenarios where the battery unit is already charged fully, the process 700 may transmit an instruction to the one or more renewable energy sources to reduce the energy output.

However, if the energy output does not exceed the load demand, in yet more embodiments, the process 700 may operate the battery unit in a discharging mode to satisfy the load demand (block 760). For example, based on a comparison between the load demand and the energy output of the one or more renewable energy sources, the process 700 may determine that the energy output is not sufficient to satisfy the load demand. In other words, the process 700 may determine that the one or more renewable energy sources may not be producing sufficient energy to meet the load demand. Therefore, the process 700 may transmit an instruction to the battery unit to operate in the discharging mode to compensate for load demand that is in excess to the energy output.

Although a specific embodiment for grid support functions and renewable energy source power management for a network device suitable for carrying out the various steps, processes, methods, and operations described herein is discussed with respect to FIG. 7, any of a variety of systems and/or processes may be utilized in accordance with embodiments of the disclosure. In many additional embodiments, the power from the utility power grid may provide an indication of whether the power is from a renewable source or a non-renewable source. Thus, the process 700 may operate the battery unit in the charging mode when the power supplied from the utility power grid is from a renewable source, such as solar power, wind power, or the like. This may support the process 700 in using green energy solutions. In a similar manner, the process 700 may operate the battery unit in the discharging mode when the power supplied from the utility power grid is from a non-renewable source. In this situation, the process 700 may operate the battery unit to supply power to the internal components of the network device or to the external device. The elements depicted in FIG. 7 may also be interchangeable with other elements of FIGS. 1-6 and 8-13 as required to realize a particularly desired embodiment.

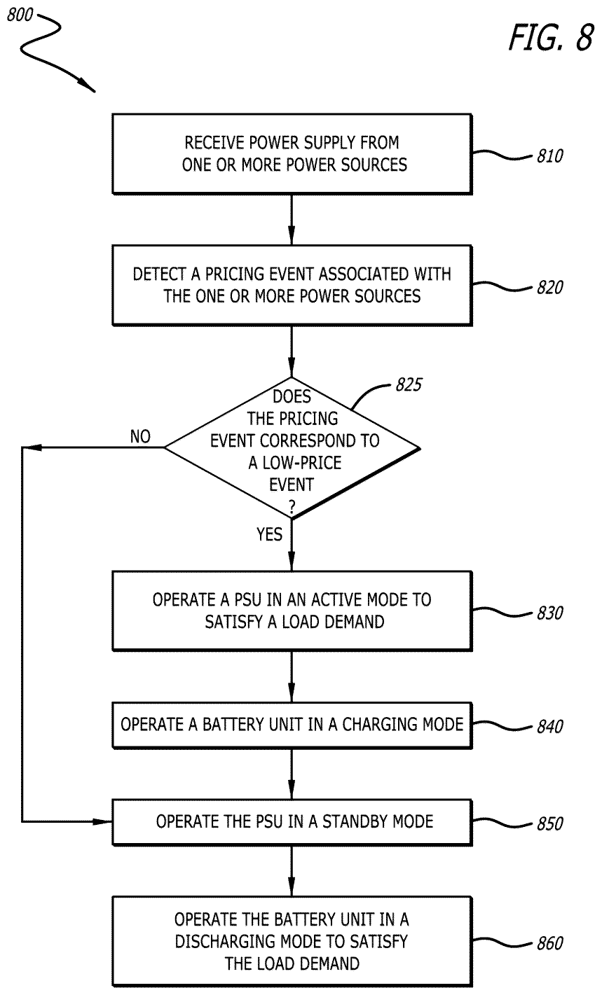

Referring to FIG. 8, a flowchart showing a process 800 for energy arbitrage in a network device in accordance with various embodiments of the disclosure is shown. In many embodiments, the process 800 may receive power supply from one or more power sources (block 810). The one or more power sources may include, for example, a utility power grid, one or more renewable energy source, one or more non-renewable energy source, or the like. Examples of the renewable energy sources may include wind energy, solar energy, or any other type of green energy source. The non-renewable energy source may include those power sources that generate power from non-renewable sources such as fossil fuels, nuclear fuels, or the like.

In a variety of embodiments, the process 800 may detect a pricing event associated with the one or more power sources (block 820). The pricing event may refer to electricity pricing of the power supplied from the utility power grid. For example, the pricing event may indicate a per unit price associated with each power source. In many scenarios, the utility power grid may vary the pricing of the electricity throughout the day, and it may be referred to as time-of-use (ToU) pricing. The electricity pricing may depend upon various factors such as demand, fuel prices, grid congestion, etc. During peak periods, for example, as weekday evenings when people may use appliances and electronics at home, the electricity prices may be set higher. Off-peak hours may refer to times of low demand, for example, overnight when most people are asleep, the electricity prices may be set lower. The concept of buying and selling electricity or energy commodities in different markets or time periods to profit from differences in prices may be referred to as energy arbitrage.

In more embodiments, the process 800 may determine if the pricing event corresponds to a low-price event (block 825). If the process 800 determines that the pricing event corresponds to a low-price event, in additional embodiments, the process 800 may operate a PSU in an active mode to satisfy a load demand (block 830). The low-price event may refer to a period during which the electricity prices drop by a significant amount. During several embodiments, the low-price event may refer to negative electricity pricing (such as electricity exchange falls below zero). In such situations, grid operators may pay or incentivize customers to increase electricity usage during negative electricity pricing event. This implies that during a low or negative electricity pricing event, the process 800 may utilize the PSU to supply the power received from the utility power grid. Thus, the overall operational cost may be optimized.

In additional embodiments, the process 800 may operate a battery unit in a charging mode (block 840). The process 800 may operate the battery unit of the network device in the charging mode based on the determined low electricity pricing event. The battery unit may thus get charged when the electricity pricing may be low or negative, and thereby improving the overall cost efficiency.

However, if the pricing event corresponds to a high-price event, in further embodiments, the process 800 may operate the PSU in a standby mode (block 850). In standby mode, the PSU may not supply any power to satisfy the load demand. Instead, the PSU may decrease its power output to a minimum level required to keep essential components operational.

In still more embodiments, the process 800 may operate the battery unit in a discharging mode to satisfy the load demand (block 860). The process 800 may transmit an instruction to the battery unit to operate in the discharging mode and supply power to satisfy the load demand. Consequently, the process 800 may optimize the usage of power from the PSU and/or the battery unit based on the pricing event to ensure cost savings.

Although a specific embodiment for energy arbitrage in a network device suitable for carrying out the various steps, processes, methods, and operations described herein is discussed with respect to FIG. 8, any of a variety of systems and/or processes may be utilized in accordance with embodiments of the disclosure. In many additional embodiments, the utility power grid may use the concept of demand response in which the utility power grid may incentivize consumers to adjust their electricity usage in response to supply conditions, grid constraints, or price signals. For example, the utility power grid may incentivize the consumers for using the stored battery energy during peak demand periods. The elements depicted in FIG. 8 may also be interchangeable with other elements of FIGS. 1-7 and 9-13 as required to realize a particularly desired embodiment.

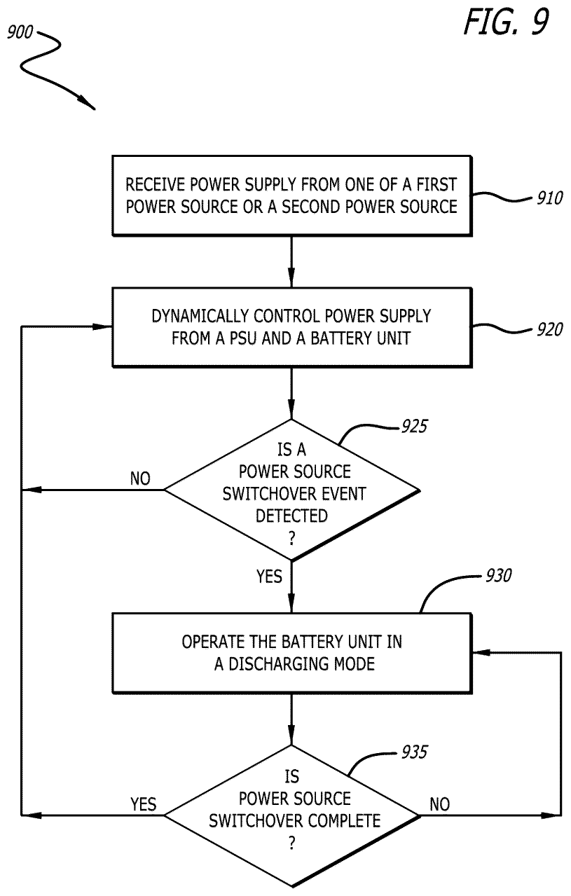

Referring to FIG. 9, a flowchart showing a process 900 for utilizing a battery unit to support a power source switchover event of a network device in accordance with various embodiments of the disclosure is shown. In many embodiments, the process 900 may receive power supply from one of a first power source or a second power source (block 910). In numerous embodiments, a network device may be connected to multiple power sources (e.g., the first power source and the second power source) and may designate one of the power sources as a primary power source and the other power sources as secondary power sources which can be utilized to draw power when the primary power source becomes unavailable. In an example, the first power source can be a utility power grid and the second power source can be a backup power source such as a renewable energy source.

In more embodiments, the process 900 may dynamically control power supply from a PSU and a battery unit (block 920). The battery unit may be disposed within a PSU slot or a linecard slot of the network device. The process 900 may evaluate various parameters such as a time of day, load demand, voltage fluctuations, or the like and dynamically select at least one of the PSU or the battery unit to supply power. For example, if the process 900 determines that evening times are usually peak periods for electricity pricing and thus supplying power through the PSU may not be cost effective, the process 900 may select and control the battery unit to supply power during the peak periods. In such periods, the PSU can be operated in a standby mode by the process 900.

In additional embodiments, the process 900 may detect a power source switchover event (block 925). The power source switchover event may refer to switching over the power supply from the first power source to the second power source or from the second power source to the first power source. For example, the process 900 may detect that the power supply is being switched from the utility power grid to the renewable energy source or from the renewable energy source to the utility power grid.

If the power source switchover event is detected, in further embodiments, the process 900 may operate the battery unit in a discharging mode (block 930). During the power source switchover event, there may be power fluctuations or power supply may be interrupted for brief periods. Thus, by operating the battery unit in the discharging mode, the process 900 may ensure that the power supply to the device's components and external powered devices is not interrupted during the power source switchover.

In still more embodiments, the process 900 may determine whether the power source switchover is complete (block 935). If the power source switchover is complete, the process 900 may continue to dynamically control the power supplied from the PSU and the battery unit (block 920). However, if the power source switchover is not complete, in still further embodiments, the process 900 may continue to operate the battery unit in the discharging mode (block 930).

Although a specific embodiment regarding utilizing a battery unit to support a power source switchover event of a network device suitable for carrying out the various steps, processes, methods, and operations described herein is discussed with respect to FIG. 9, any of a variety of systems and/or processes may be utilized in accordance with embodiments of the disclosure. In a number of embodiments, the second power source may correspond to a backup power generator connected to the network device. The elements depicted in FIG. 9 may also be interchangeable with other elements of FIGS. 1-8 and 10-13 as required to realize a particularly desired embodiment.

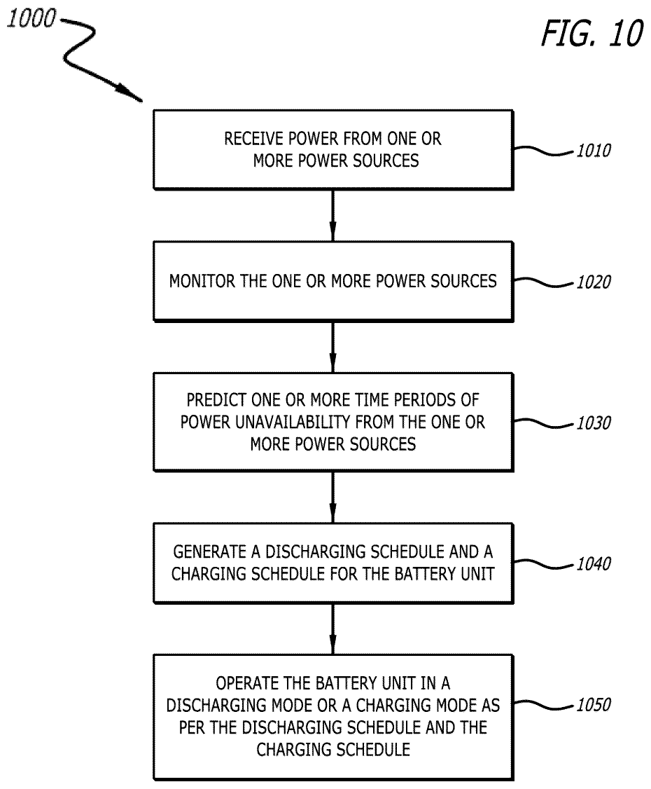

Referring to FIG. 10, a flowchart showing a process 1000 for predictive control of a battery unit included in a network device in accordance with various embodiments of the disclosure is shown. In many embodiments, the process 1000 may receive power from one or more power sources (block 1010). The one or more power sources may include a utility power grid, one or more renewable energy sources, one or more non-renewable energy source, or the like. The network device may be connected the one or more power sources for received power for its operation.

In a number of embodiments, the process 1000 may monitor the one or more power sources (block 1020). The process 1000 may monitor various operational statuses of the power sources for example, pricing event, amount of supplied power, capacity, etc. The process 1000 may also monitor which power source may be operational at which time, under what situational parameters (e.g., weather, environmental factors, time of day, etc.) and for how much duration. For example, the process 1000 may analyze historical power availability data and learn one or more trends of power unavailability.

In a variety of embodiments, the process 1000 may predict one or more time periods of power unavailability from the one or more power sources (block 1030). The process 1000 may predict one or more time periods of power unavailability from a power source based on historical power availability data and/or one or more environmental factors associated with the power source. For example, based on the historical power supply data, the process 1000 may learn that power supply from the utility power grid was interrupted multiple times in the past during stormy weather conditions. Consequently, the process 1000 may predict that due to a stormy weather forecast for a particular day of the week, for a particular time duration, power supply from the utility power grid may be disrupted. In a similar manner, the process 1000 may predict that due to cloudy overcast, power supply from the solar panels may be disrupted over the weekend. Further, continuing with the example, the process 1000 may receive information regarding scheduled maintenance of the power grid over the weekend from 10:00 AM-4:00 PM, and thus may predict the power unavailability from the power grid during that time period. In other words, the process 1000 may analyze historical power availability data and/or one or more environmental factors and predict the one or more time periods during which the power may be unavailable from the one or more power sources connected to the network device.

In more embodiments, the process 1000 may generate a discharging schedule and a charging schedule for the battery unit (block 1040). The process 1000 may generate the charging schedule and the discharging schedule for the battery unit based on the predicted power unavailability from the one or more power sources for a particular time period. For example, the process 1000 may generate the discharging schedule that ensures that the battery unit discharges during the one or more time periods of power unavailability. Similarly, the process 1000 may generate the charging scheduled that ensures that the battery unit charges based on the prediction of the one or more time periods of power unavailability. The process 1000 may further align the charging schedule of the battery unit with the one or more time periods of power unavailability to maintain energy reserves in the battery unit for the one or more time periods of power unavailability. For example, the charging schedule may be generated in a manner that the battery unit gets charged prior to any discharging event described in the discharging schedule. The discharging schedule and the charging schedule may indicate time-periods during which the battery units are to be discharged and charged, respectively.

In additional embodiments, the process 1000 may operate the battery unit in a discharging mode or a charging mode as per the discharging schedule and the charging schedule (block 1050). For example, the process 1000 may transmit instructions to the battery unit to operate in the discharging mode on those time-periods that are indicated in the discharging schedule. Similarly, the process 1000 may transmit instructions to the battery unit to operate in the charging mode on those time-periods that are indicated in the charging schedule. The process 1000 may thus be able to better manage the uninterrupted power to the network device components or any external device by utilizing the battery unit.

Although a specific embodiment regarding predictive control of a battery unit included in a network device suitable for carrying out the various steps, processes, methods, and operations described herein is discussed with respect to FIG. 10, any of a variety of systems and/or processes may be utilized in accordance with embodiments of the disclosure. In a number of embodiments, process 1000 may use an ML model to predict the one or more time periods of power unavailability from the one or more power sources. The ML model, for example, may utilize historical data to provide the predictions. In several embodiments, the ML model can also provide recommendation regarding the discharging schedule and the charging schedule for the battery unit. The elements depicted in FIG. 10 may also be interchangeable with other elements of FIGS. 1-9 and 11-13 as required to realize a particularly desired embodiment.

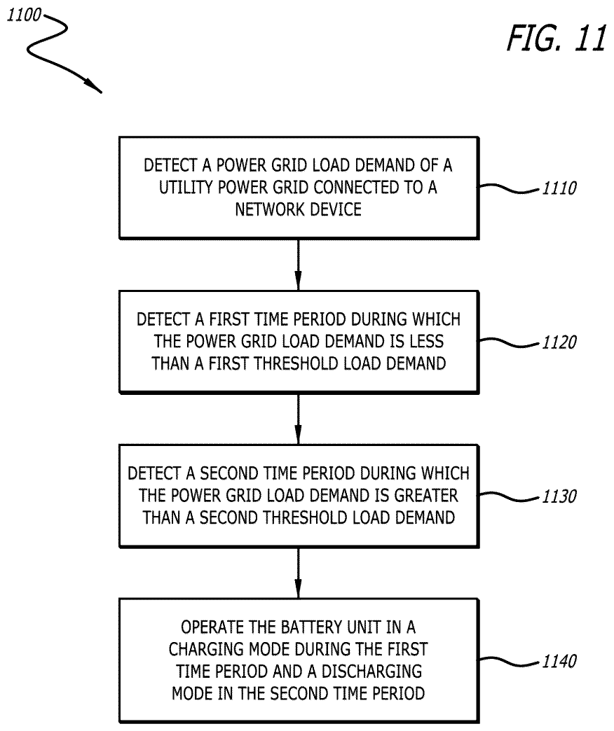

Referring to FIG. 11, a flowchart showing a process 1100 for power grid load balancing in accordance with various embodiments of the disclosure is shown. In many embodiments, the process 1100 may detect a power grid load demand associated with a utility power grid connected to a network device (block 1110). Here, the network device may refer to any networking equipment such as a router, an access point, servers, or the like. The process 1100 may receive a signal from the power grid indicating the power grid load demand handled by the utility power grid. In an example, the signal may indicate a low load demand or a high load demand. In numerous embodiments, the signal may be received in accordance with a demand-response program associated with the utility power grid.

In a number of embodiments, the process 1100 may detect a first time period during which the power grid load demand is less than a first threshold load demand (block 1120). The first threshold load demand may refer to a boundary limit below which the power grid load demand may be considered low. The power grid load demand being less than the first threshold load demand may indicate that the utility power grid has surplus power. The process 1100 may determine a particular time period during which the power grid load demand is less than the first threshold load demand. In numerous additional embodiments, the process 1100 may detect the first time period by analyzing historical load data of the utility power grid, for example, historical load data may indicate when was the power grid overutilized and underutilized in the past.

In a variety of embodiments, the process 1100 may detect a second time period during which the power grid load demand is greater than a second threshold load demand (block 1130). The second threshold load demand may refer to a boundary limit beyond which the power grid load demand may be considered high. The power grid load demand being greater than the second threshold load demand may indicate that the utility power grid may be experiencing shortage of power. In numerous additional embodiments, the process 1100 may detect the second time period by analyzing the historical load data of the utility power grid.

In more embodiments, the process 1100 may operate the battery unit in a charging mode during the first time period and a discharging mode in the second time period (block 1140). The process 1100 may transmit an instruction to the battery unit to operate in the charging mode to store excess energy available at the utility power grid. Similarly, during the second time period, the process 1100 may transmit an instruction to the battery unit to operate in the discharging mode to supply power to the utility power grid. In various embodiments, the process 1100 may transmit a power supply signal from the power grid to the battery unit. The process 1100 may operate the battery unit to filter one or more fluctuations in the power supply signal and to store the excess energy.

Although a specific embodiment regarding power grid load balancing suitable for carrying out the various steps, processes, methods, and operations described herein is discussed with respect to FIG. 11, any of a variety of systems and/or processes may be utilized in accordance with embodiments of the disclosure. In several embodiments, process 1100 may receive an indication from the power grid to operate the battery unit in charging or discharging mode based on the determined load demand and power supply. For example, during periods of low load demand and excess electricity generation, the process 1100 may receive an indication from the power grid to store the excess energy in the battery unit. The elements depicted in FIG. 11 may also be interchangeable with other elements of FIGS. 1-10 and 12-13 as required to realize a particularly desired embodiment.

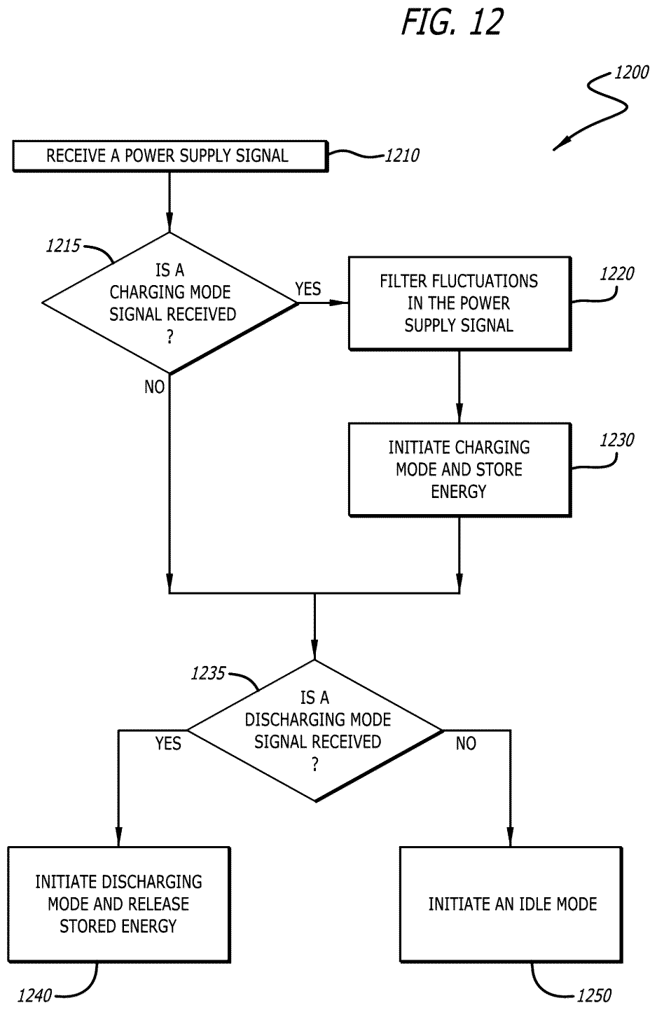

Referring to FIG. 12, a flowchart showing a process 1200 for different operational modes of a battery unit in accordance with various embodiments of the disclosure is shown. In many embodiments, the process 1200 may receive a power supply signal (block 1210). The power supply signal may be received by a battery unit disposed within a linecard slot or a PSU slot of a network device. The power supply signal can be received from one or more power sources such as a utility power grid, a renewable energy source, a non-renewable energy source, or the like.

In a number of embodiments, the process 1200 may determine whether a charging mode signal is received (block 1215). The charging mode signal can correspond to a trigger signal received by the battery unit, indicating it to start charging. In additional embodiments, the charging mode signal may be provided by a power management logic implemented in the network device to dynamically control power supplied by the battery unit.

If the charging mode signal is received, in a variety of embodiments, the process 1200 may filter fluctuations in the power supply signal (block 1220). The power supply signals may be filtered to remove fluctuations or variations in the power supply signals that can lead to undesirable effects on the performance, functionality, and longevity of electronic components and circuits. In further embodiments, the process 1200 may initiate the charging mode and store energy (block 1230). The energy may be stored in one or more charging storage elements of the battery unit.

However, if the charging mode signal is not received, in still further embodiments, the process 1200 may check whether a discharging mode signal is received (block 1235). The discharging mode signal can correspond to a trigger signal received by the battery unit, indicating it to start discharging. In additional embodiments, the discharging mode signal may be provided by the power management logic implemented in the network device to dynamically control power supplied by the battery unit. The process 1200, in many further embodiments, may initiate the discharging mode and release the stored energy (block 1240). The battery unit may release the stored energy.

In several more embodiments, if any of the charging mode signal or the discharging mode signal is not received, the process 1200 may initiate an idle mode (block 1250). In the idle mode, the battery unit may not store any additional charge and may not supply any power.

Although a specific embodiment regarding the different operational modes of a battery unit suitable for carrying out the various steps, processes, methods, and operations described herein is discussed with respect to FIG. 12, any of a variety of systems and/or processes may be utilized in accordance with embodiments of the disclosure. In several more embodiments, for example, the process 1200 may receive a bypass signal, based on which, the battery unit may filter the power supply signal and provide the filtered power supply signal to a power bus of the network device without charging or discharging. The elements depicted in FIG. 12 may also be interchangeable with other elements of FIGS. 1-11 and 13 as required to realize a particularly desired embodiment.

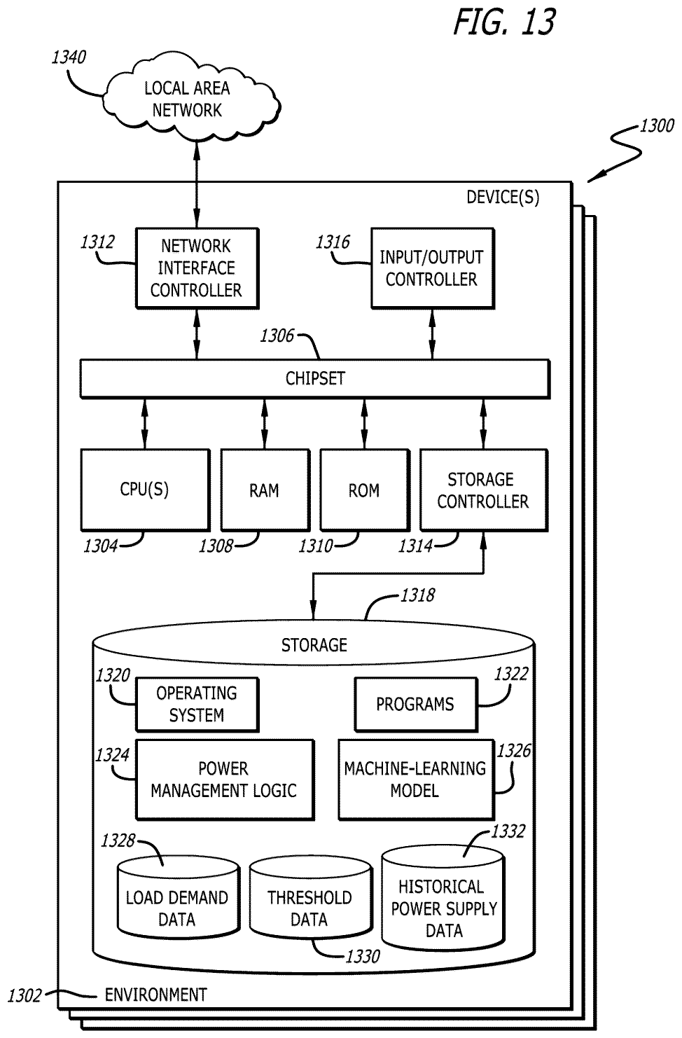

Referring to FIG. 13, a conceptual block diagram for one or more devices 1300 capable of executing components and logic for implementing the functionality and embodiments described above is shown. The embodiment of the conceptual block diagram depicted in FIG. 13 can illustrate a conventional server computer, workstation, desktop computer, laptop, tablet, network appliance, e-reader, smartphone, or other computing device, and can be utilized to execute any of the application and/or logic components presented herein. The device 1300 may, in some examples, correspond to physical devices or to virtual resources described herein.

In many embodiments, the device 1300 may include an environment 1302 such as a baseboard or “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In more embodiments, one or more processors 1304, such as, but not limited to, central processing units (“CPUs”) can be configured to operate in conjunction with a chipset 1306. The processor(s) 1304 can be standard programmable CPUs that perform arithmetic and logical operations necessary for the operation of the device 1300.

In additional embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In yet more embodiments, the chipset 1306 may provide an interface between the processor(s) 1304 and the remainder of the components and devices within the environment 1302. The chipset 1306 can provide an interface to a random-access memory (“RAM”) 1308, which can be used as the main memory in the device 1300 in some embodiments. The chipset 1306 can further be configured to provide an interface to a computer-readable storage medium such as a read-only memory (“ROM”) 1310 or non-volatile RAM (“NVRAM”) 1308 for storing basic routines that can help with various tasks such as, but not limited to, starting up the device 1300 and/or transferring information between the various components and devices. The ROM 1310 or NVRAM 1308 can also store other application components necessary for the operation of the device 1300 in accordance with various embodiments described herein.

Different embodiments of the device 1300 can be configured to operate in a networked environment using logical connections to remote computing devices and computer systems through a network, such as the network 1340. The chipset 1306 can include functionality for providing network connectivity through a network interface card (“NIC”) 1312, which may comprise a gigabit Ethernet adapter or similar component. The NIC 1312 can be capable of connecting the device 1300 to other devices over the network 1340. It is contemplated that multiple NICs 1312 may be present in the device 1300, connecting the device to other types of networks and remote systems.

In further embodiments, the device 1300 can be connected to a storage 1318 that provides non-volatile storage for data accessible by the device 1300. The storage 1318 can, for example, store an operating system 1320, applications 1322, and data 1328, 1330, 1332, which are described in greater detail below. The storage 1318 can be connected to the environment 1302 through a storage controller 1314 connected to the chipset 1306. In yet more embodiments, the storage 1318 can consist of one or more physical storage units. The storage controller 1314 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1300 can store data within the storage 1318 by transforming the physical state of the physical storage units to reflect the information being stored. The specific transformation of physical state can depend on various factors. Examples of such factors can include, but are not limited to, the technology used to implement the physical storage units, whether the storage 1318 is characterized as primary or secondary storage, and the like.

For example, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to device 1300. Stated otherwise, some or all of the operations performed by the cloud computing network, and or any components included therein, may be performed by one or more devices 1300 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1318 can store an operating system 1320 utilized to control the operation of the device 1300. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1318 can store other system or application programs and data utilized by the device 1300.

In various embodiment, the storage 1318 or other computer-readable storage media is encoded with computer-executable instructions which, when loaded into the device 1300, may transform it from a general-purpose computing system into a special-purpose computer capable of implementing the embodiments described herein. These computer-executable instructions may be stored as application 1322 and transform the device 1300 by specifying how the processor(s) 1304 can transition between states, as described above. In some embodiments, the device 1300 has access to computer-readable storage media storing computer-executable instructions which, when executed by the device 1300, perform the various processes described above with regard to FIGS. 1-12. In more embodiments, the device 1300 can also include computer-readable storage media having instructions stored thereupon for performing any of the other computer-implemented operations described herein.

In still further embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 might not include all of the components shown in FIG. 13 and can include other components that are not explicitly shown in FIG. 13, or might utilize an architecture completely different than that shown in FIG. 13.

As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

In many embodiments, the device 1300 can include a power management logic 1324 that can be configured to perform one or more of the various steps, processes, operations, and/or other methods that are described above. Often, the power management logic power management logic 1324 can be a set of instructions stored within a non-volatile memory that, when executed by the processor(s)/controller(s) 1304 can carry out these steps, etc. In some embodiments, the power management logic 1324 may be a client application that resides on a network-connected device, such as, but not limited to, a server, switch, a router, personal or mobile computing device, an access point (AP). In yet more embodiments, the power management logic 1324 can dynamically control various PSUs and battery units in the device 1300 to power a load (e.g., internal load and/or external load) (e.g., to satisfy a load demand).

In several embodiments, the power management logic 1324 may detect a load demand associated with the device 1300, monitor various power sources connected to the device 1300, and dynamically operate each PSU in one of an active mode or a standby mode and each battery unit in one of a charging mode, a discharging mode, or an idle mode based on the load demand and the monitored power sources. In other words, the power management logic 1324 can enable the PSUs, the battery units, or a combination thereof to match the load in a manner that the required device efficiency may be achieved. Further, the power management logic 1324 may not utilize the battery unit as a mere passive back-up for the PSUs but as an active unit that participates in load sharing with the PSUs. In additional embodiments, the power management logic 1324 may utilize the battery unit for executing one or more grid support functions, green charge management functions, energy arbitrage functions, predictive control, or the like.

In a number of embodiments, the storage 1318 can include load demand data 1328 associated with the device 1300 (for example, a router). In a variety of embodiments, the load demand data 1328 may indicate power required by various internal components (for example, memory, microprocessors, serial ports, Universal Serial Bus (USB) ports, console ports, and other internal circuitry of the device 1300) and/or various external devices (for example, Internet Protocol (IP) Phone, IP Cameras, VoIP Phones, or the like) powered by the device 1300. In several embodiments, the load demand data 1328 may indicate a time-series of load demand handled by the device 1300. The load demand data 1328 may be utilized by the power management logic 1324 to predict future load demand associated with the device 1300.

In various embodiments, the storage 1318 can include threshold data 1330. The threshold data 1330 can comprise multiple stored values of the load demand such as a first threshold value, a second threshold value, or the like. In many further embodiments, the threshold data 1330 may be used to determine whether the one or more PSUs, the battery unit, or a combination thereof can satisfy the load demand. For example, in several embodiments, the threshold data 1330 may store the first threshold value indicating a load demand in a power saving mode or a sleep state of the device 1300. In several additional embodiments, the threshold data 1330 may store the second threshold value indicating a load demand beyond which the PSUs can operate in their peak efficiency load range.

In still additional embodiments, the storage 1318 can include historical power supply data 1332. In numerous embodiments, the historical power supply data 1332 may refer to past power supply data of one or more power sources connected to the device 1300. For example, the historical power supply data 1332 may indicate the time durations, situational parameters, etc. during which power supply of a power source was interrupted in the past. For example, the historical power supply data 1332 may indicate that every first Saturday of the month a routine maintenance activity for the utility power grid is conducted which results in a power outage between 10:00 AM to 11:00 AM. Thus, the power management logic 1324 may utilize the historical power supply data 1332 to predict time periods of power unavailability and accordingly generate charging and discharging schedules for the battery unit.

Finally, in many embodiments, data may be processed into a format usable by a machine-learning model 1326 (e.g., feature vectors), and or other pre-processing techniques. The machine-learning (“ML”) model 1326 may be any type of ML model, such as supervised models, reinforcement models, and/or unsupervised models. The ML model 1326 may include one or more of linear regression models, logistic regression models, decision trees, Naïve Bayes models, neural networks, k-means cluster models, random forest models, and/or other types of ML models 1326. The ML model 1326 may be configured to detect patterns regarding load demand, one or more power supply sources, time of the day, weather data, or the like, and accordingly make predictions. For example, the ML model 1326 may learn that during weekday afternoons load demand is very low in residential accommodations. Consequently, the ML model 1326 may recommend utilizing the battery unit to satisfy the low load demand, ensuring that PSUs operate in their peak efficiency load range.

The ML model(s) 1326 can be configured to generate inferences to make predictions or draw conclusions from data. An inference can be considered the output of a process of applying a model to new data. This can occur by learning from infrastructure data, sustainability data, and/or health data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1326 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
one or more power supply units (PSUs);
a plurality of linecard slots;
a battery unit disposed within a linecard slot of the plurality of linecard slots, wherein the one or more PSUs and the battery unit are configured to supply power to the device; and
a memory communicatively coupled to the processor, wherein the memory comprises a power management logic that is configured to:
determine a load demand associated with the device;
monitor one or more power sources providing power to the battery unit and the one or more PSUs; and
dynamically control the power supplied from the one or more PSUs and the battery unit based on the determined load demand and the monitored one or more power sources.

2. The device of claim 1, wherein the one or more power sources include at least one of: a utility power grid, a renewable energy source, or a non-renewable energy source.

3. The device of claim 2, wherein, in response to the one or more power sources including the utility power grid, the power management logic is further configured to facilitate one or more grid support functions via the battery unit.

4. The device of claim 3, wherein the one or more grid support functions include at least one of: frequency regulation, voltage control, or load balancing for the utility power grid.

5. The device of claim 4, wherein, in response to the one or more grid support functions including load balancing, the power management logic is further configured to:
detect a time period during which a power grid load demand is less than a threshold load demand; and
operate the battery unit in a charging mode during the detected time period, wherein the charging mode comprises storing excess energy from the utility power grid, during the detected time period, in the battery unit.

6. The device of claim 5, wherein, in the charging mode, the battery unit is configured to:
receive a power supply signal from the utility power grid; and
filter one or more fluctuations in the power supply signal to store the excess energy.

7. The device of claim 4, wherein, in response to the one or more grid support functions including load balancing, the power management logic is further configured to:
detect a time period during which a power grid load demand is greater than a threshold load demand; and
operate the battery unit in a discharging mode during the detected time period, wherein the discharging mode comprises releasing energy from the battery unit to the utility power grid during the detected time period.

8. The device of claim 2, wherein, in response to the one or more power sources including the renewable energy source, the power management logic is further configured to monitor an energy output associated with the renewable energy source.

9. The device of claim 8, wherein the power management logic is further configured to:
detect that the energy output associated with the renewable energy source exceeds the determined load demand; and
operate the battery unit in a charging mode in response to detecting that the energy output exceeds the determined load demand, wherein the charging mode comprises storing excess energy output of the renewable energy source in the battery unit.

10. The device of claim 8, wherein the power management logic is further configured to:
detect that the energy output associated with the renewable energy source is less than the determined load demand; and
operate the battery unit in a discharging mode in response to detecting that the energy output is less than the determined load demand, wherein the discharging mode comprises releasing energy stored in the battery unit to satisfy the load demand.

11. The device of claim 1, wherein the power management logic is further configured to:
detect a pricing event associated with the one or more power sources; and
control charging and discharging of the battery unit based on the detected pricing event.

12. The device of claim 1, wherein the power management logic is further to:
detect a power source switchover event associated with the device; and
operate the battery unit in a discharging mode during the power source switchover event.

13. The device of claim 1, wherein dynamically controlling the power supplied from the one or more PSUs and the battery unit comprises:
operating the one or more PSUs in one of an active mode or a standby mode based on the determined load demand and a PSU efficiency parameter; and
operating the battery unit in one of a charging mode, a discharging mode, or an idle mode based on the determined load demand.

14. The device of claim 13, wherein dynamically controlling the power supplied from the one or more PSUs and the battery unit further comprises:
operating at least one of the PSU among the one or more PSUs in an active mode based on the determined load demand; and
operating the battery unit in a discharging mode based on the determined load demand.

15. The device of claim 1, wherein the power management logic is further to configured to:
predict one or more time periods of power unavailability from the one or more power sources;
generate a discharging schedule for the battery unit based on the prediction of the one or more time periods of power unavailability; and
operate the battery unit in a discharging mode based on the discharging schedule.

16. The device of claim 15, wherein the power management logic predicts the one or more time periods of power unavailability based on at least one of historical power availability data or one or more environmental factors.

17. The device of claim 15, wherein the power management logic is further to configured to:
generate a charging schedule for the battery unit based on the prediction of the one or more time periods of power unavailability; and
operate the battery unit in a charging mode based on the charging schedule.

18. The device of claim 17, wherein the charging schedule is aligned with the one or more time periods of power unavailability to maintain energy reserves in the battery unit for the one or more time periods of power unavailability.

19. A device, comprising:
a processor;
a plurality of power supply unit (PSU) slots including at least a first PSU slot and a second PSU slot;
a PSU disposed within the first PSU slot;
a battery unit disposed within the second PSU slot, wherein the PSU and the battery unit are configured to supply power to the device; and
a memory communicatively coupled to the processor, wherein the memory comprises a power management logic that is configured to:
determine a load demand associated with the device;
monitor one or more power sources providing power to the PSU and the battery unit; and
dynamically control the power supplied from the PSU and the battery unit based on the determined load demand and the monitored one or more power sources.

20. A method, comprising:
determining a load demand associated with a network device, wherein the network device comprises one or more power supply units (PSUs) and a battery unit disposed within a linecard slot in the network device;
monitoring one or more power sources providing power to the battery unit and the one or more PSUs; and
dynamically controlling a power supply from the one or more PSUs and the battery unit based on the determined load demand and the monitored one or more power sources.
